(19) United States
(12) Patent Application Publication
(10) Pub. No.: US 2018/0336601 A1
(43) Pub. Date: Nov. 22, 2018

(54) Securitization of Virtual Objects

(71) Applicant: Rujing Tang, Plano, TX (US)

(72) Inventor: Rujing Tang, Plano, TX (US)

(73) Assignee: Rujing Tang, Plano, TX (US)

(21) Appl. No.: 15/945,740

(22) Filed: Apr. 5, 2018

Related U.S. Application Data
(60) Provisional application No. 62/509,191, filed on May 22, 2017.

(51) Int. Cl. G06Q 30/02; G06F 17/30; G06Q 20/22

(52) U.S. Cl. CPC G06Q 30/0277; G06Q 20/22; G06F 17/30864

(57) ABSTRACT

Virtual objects may generate recurring cash flows. Based on when, where, who and how the cash flows are generated, the virtual objects may be further divided into different tradable securities. A securitization document is established for a virtual object or a securitized package. The owner of the security is entitled to cash flows identified in the securitization document. A secondary market may be established for such securitized virtual objects, or virtual object ownership.

### CROSS-REFERENCE

Priority is claimed from the U.S. Provisional Patent application No. 62/509,191, entitled “Securitization of Virtual Objects”, filed on May 22, 2017; entirety of which is hereby incorporated by reference.

### BACKGROUND

In digital world, users come into contact with various virtual objects, such as images, texts, keywords, locations, addresses, audios and videos in a software application. However, traditionally, these virtual objects are not viewed as independently assets.

### BRIEF SUMMARY

Certain terms are used throughout the following description and claims to refer to particular system components. As one skilled in the art will appreciate, different companies may refer to a component and/or method by different names. This document does not intend to distinguish between components and/or methods that differ in name but not in function.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device that connection may be through a direct connection or through an indirect connection via other devices and connections.

A virtual object in the context of this document refers to digital records which are created and defined by a software application.

A virtual object may exist only in the software application.

Some of the virtual objects may bring cash flow to the legal owner of the virtual objects. The cash flow may come from advertisers, fees and other types of payments made by other entities. However virtual object ownership has not been fully explored and the cash flows have largely remained in its simplest forms.

One example of virtual object is the virtual locations or regions on a digital map. Although the discussion below details the process in a map application, it should be noted that the map application is only one example of virtual object securitization.

When a user opens a digital map application on a computing device, the user can view the digital map. The user can further search point of interest (POI) or key words such as ‘nearby events’. The map displays the queried information. Some of the information provided by a content provider is tied to a specific address on the map. The user would view or take further actions on that specific location on the digital map. For instance, the user may search for nearby flash sales on a map, and the addresses where there are ongoing flash sales would display a flag for the user to further click on. Once clicked, a larger display area will pop up for more details about the sale happening at the location.

Advertiser is a type of content provider. When the user pays attention to a location or a region on the digital map, the advertiser may plant advertisement for the user to view. Sometimes the advertisement is like a virtual billboard. As a result, there is a cash flow from the advertiser that is tied to that region or location. Cash flows of other sources is also possible, for instance, content provider such as job poster and event organizer may pay a fee for listing in that address or region. In the past, the cash flow would be paid to the digital map application developer.

A new business process may be introduced to securitize the cash flows. An individual or an organization may be named as the ‘virtual landlord’ of a specific address or a region on the digital map. As the virtual landlord, he or she may be entitled to at least a portion of the cash flow generated from the owned address or location.

As long as it is made clear to involved parties, there is no need to make the virtual landlord coincident with the physical landlord or anyone who has physical relations with that address or region.

Because demographic is related to geo-locations, different regions or address on a digital maps tend to be viewed by users of different demographics, which makes each address or region have different cash flow generating capabilities.

The cash flows from the address or regions are of recurring nature, and that makes it possible to price the virtual landlord title in a securitization process.

A cash flow related to an address or a region may be stratified based on when a user effectuates the cash flow. Daytime and night time accesses are vastly different from a user and an advertiser's perspective. The cash flow is also predictably different for the same address or region.

Another example is the keywords search in a search engine application. For instance, keywords related to housing and keywords related to philosophy have very different cash generating capabilities from advertisers' standpoint. Therefore different category of keywords may be used to stratify the cash flows.

A legal document called securitization document is created for tying the virtual object and the related cash flows during a securitization step. The document may at least define the legal rights and obligations of the security owner, the security identifier, the underlying cash flow definition and ownership information. For instance, the document may define what cash flow is expected to be attributable to the security owner. It also has a unique identifier for such security for later trading and record keeping.

It is possible to price the virtual landlordship. Some methods such as discounted future cash flow coupled with data analytics may be employed to reach a valuation of the virtual landlordship of an address or a region. This virtual landlordship of the same address may be further subdivided into different groups based on different criteria such as user's country. Locations on the map application accessed by users from the same country can be packaged together.

The securitization step may be performed by the software developer who created the virtual objects. Alternatively the securitization may be performed by a third party service provider. Once the virtual landlordship securitization is finished, or in other words, the cash flows are clearly defined, there is a price discovery process, through market mechanisms. There is a secondary market for trading various virtual landlordship.

For instance, one tradable security example for virtual landlordship is: 123 Main Street, San Francisco, Calif. 99999, USA. Another example is: 123 Main Street, 7AM to 12PM. Another example is ZIP code 99999 for keywords search comprising ‘housing’. Yet another example is: Wal-mart's addresses. Yet another example is: 123 Main Street, CA 99999 related to job posters.

Depending on circumstances, the virtual landlord of an address or a region may be responsible for the content posted on the address or region. For example, a physical store may also own the virtual address of the same store. It can post flash sales or other location based service information on the map application. In other cases, the virtual landlord may be a passive cash flow collector.

Cash flow may also result from a location based service. For instance, a user might be physically present at a location, and some advertisement or services based on user physical locations may be consumed or generated by the user which leads to cash flow. The cash flow may also be attributable to the virtual landlord, that is, the owner of the security assigned with that address.

The digital map application developer may have the authority of securitizing the virtual landlordship and maintaining a market place for the trading of the virtual landlordship. The map application developer is therefore entitled to fees for such services.

The map application developer also has the initial ownership of the virtual objects, and can distribute for free or sell to the first batch of virtual landlords. Each security owner, buyer, or seller has to agree to the terms and conditions set forth in the securitization document.

The securitized virtual object increases the liquidity of the virtual asset. The securities may become investable assets by investors. It also has the benefit for driving the usage of the software application itself.

When a secondary market for trading the securities ownership has been developed, the map application developer can charge fees for transaction, account services and other services.

In the securitization and the ensuing trading of virtual landlordship, the map application developer may use virtual currencies besides real world currencies. For instance, the pricing may be in the ‘point’ system of the map application developer. The developer maintains a certain exchange ratio between one ‘point’ versus a real world currency like USD. Anyone who wishes to transact first converts USD into ‘points’ because the virtual objects are priced in ‘points’. Alternatively, the pricing may be in digital currency such as Bitcoins.

The advertisers or fee payers pay the map application developer. Based on the characteristics of the payment, the cash flow is diverted to different securities defined by the securitization documents. The owner or owners of such securities would be entitled to the payment on a real time basis or on an accrual basis, according to the securitization document.

There are many commercial benefits why virtual object securitization is appealing to the participants. For the virtual objects creator, it is a very attractive way to monetize virtual assets. For the advertisers or content providers, they have an opportunity to control the ownership of valuable virtual object and can also possibly hedge the cost increase in the future for advertising. For investors the virtual object ownership confers the right to future cash flow and is tradable (has liquidity).

It is entirely possible that any other virtual objects may be securitized in similar fashion. For instance, the keyword search such as we saw in mainstream search engines may be securitized. The advertisers pay for the preferred viewing position for a given keyword search result. The keyword itself may be viewed as a virtual object that can generate cash flows. For instance, ‘Toaster’ keyword has monetization value based on at least a portion of the future cash flows paid by advertisers for this keyword. It may be spelled out in the securitization document that all of the cash flows or a portion of the cash flows generated by a user search of ‘Toaster’ would be attributable to the ‘Toaster’ keyword security holder.

The keyword such as ‘Toaster’ is stored as a digital record in a computer device which hosts the search engine application. Typically a database is used to store such digital record. When a user searches the keyword ‘Toaster’ using the search engine application, a match is found in the stored digital records. When a cash flow is attributable to the keyword search, the cash flow is linked to the identified virtual object in the securitization document, i.e. the stored digital record with keyword ‘Toaster’. The cash flow is further attributed to the owner of the securitized virtual object, that is, the securitized keyword ‘Toaster’ based on the securitization document.

Depending on when, where, how and by whom the cash flows are generated, this keyword may be future stratified into different subcategories. It is also possible to group different virtual objects into a new package based on the sub categories. For instance, the keyword ‘Toaster’ search results posted by Amazon.com ® may be grouped together with ‘Coffee Maker’ from the same advertiser Amazon®. A securitized package may be tradable in a secondary market under one unique trading name or symbol. Another example for stratification is categorizing where the users are from. The keywords ‘Toaster’ searched by users located in the United States may be separated from the cases where ‘Toaster’ is being searched by users outside of the US. A securitized package would regroup based on users' location. Users in the US searching different keywords like ‘Toaster’ or ‘Coffee Maker’ may be regrouped together to form such a package. This securitized package is tradable as well.

Another example of virtual object is a piece of virtual equipment such as a weapon in a computer game. The player of a computer game can purchase the equipment, or rent the equipment. The securitization of the equipment may allow the owner of the security to collect cash flows from the player.

Yet another example of virtual objects is the advertisement in a computer game. Some games involve display advertisements in video game scenes. For instance, ads may be displayed on virtual billboard or a virtual store front in the game. These virtual objects can generate cash flows from the advertisement therefore may be securitized in similar ways. A secondary market may also be established for trading such securities.

Yet another example is the identifiable place in a software application for communicating with the user. For instance, the banner advertisement on a webpage is an identifiable place for showing advertisement to the user. It also has future cash flow generating capability and can be securitized in the same way.

Time slots allocated for presenting content to the user of the software application may also be securitized. For instance, the time slot at the beginning of a computer game is valuable for advertisers. The time slot may bring cash flow to its owners. After a securitization document is created and the ownership is assigned, the time slot owner can start enjoying the cash flow and also can trade the security.

In the securitization process of a virtual object ownership, one needs to avoid putting the same cash flow more than once in different securities. Every defined cash flow belongs to one security to avoid confusion as which security may receive the underlying cash flows.

Sometimes an independent auditor may check if the processes and accountings are following rules and securitization documents. An audit report may establish the confidence of the participants.

It is also possible to securitize time slots in a software application. For instance, before the game starts, advertisers can play ads. This time slot therefore has identifiable cash flows and can be further securitized in similar fashion. A securitization document identifies the time slot and the cash flow generated as a result of utilizing such time slot. The owner of such security may enjoy the cash flow and also can trade with other parties.

In many cases, a server and client architecture is adopted for a software application. Virtual objects can be accessed by the client device. The server is responsible for many steps in the securitization of the virtual objects. Most likely a database is used for storing related information for the securitized virtual objects.

There are numerous other usage scenarios for a variety of embodiments of the present invention.

### BRIEF DESCRIPTION OF THE FIGURES:

FIG. 1 depicts the flowchart of the securitization of a virtual object.

FIG. 2 depicts the flowchart of the securitization of a locations or a region of in a software application.

FIG. 3 depicts the flowchart of the securitization of a virtual object package.

FIG. 4 depicts an example electronic system for use in connection with the securitization of a virtual object.

FIG. 5 depicts an example diagram of the relationship between various components of the securitization system.

FIG. 6 depicts an example system diagram in a network environment.

FIG. 7 depicts a map application, a virtual object, and a securitization document sample.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

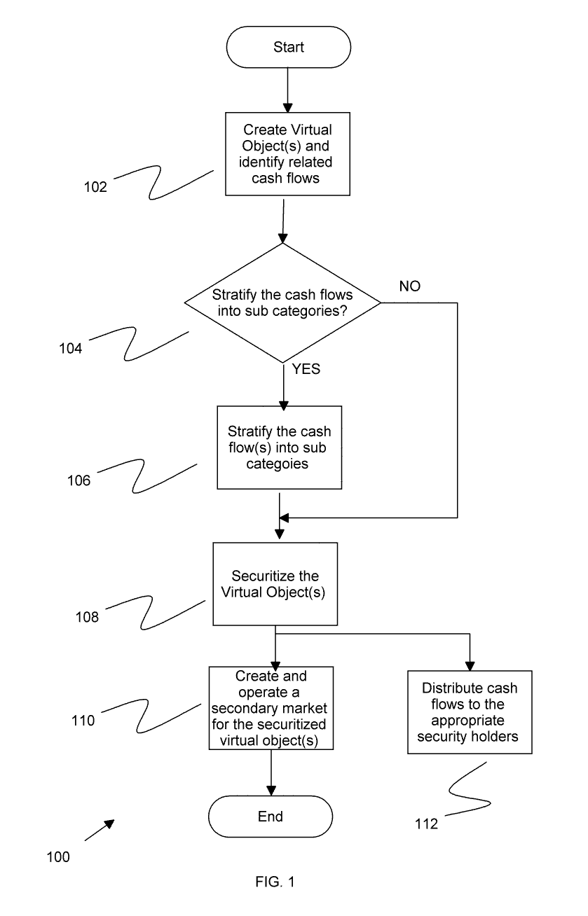

FIG. 1 depicts the flowchart of the securitization of a virtual object. The process 100 illustrates a process of securitizing a virtual object.

A software application creates a virtual object(s) in step 102. The virtual object may be a keyword, an address or a region on a map, an image, a video, an audio clip, an article, a blog, a piece of equipment used in a video game, a virtual billboard, a webpage, a page of a mobile app, a place of a webpage, a communication session, a time interval, an icon, or a text, depending on the application. The virtual object has no defined value before it is created in the application. Cash flows resulting from such virtual object(s) are also defined. For instance, in the case where the virtual object is keyword, the cash flow may be defined as the advertisement income resulting from displaying the search result of that keyword. Further a series steps may be required to actually confirm the attribution of the cash flow to the virtual object. For instance, in order to attribute the cash flow the keyword, the user of the application has to enter the keyword, and the user has to be presented with the search result that includes the cash flow generating content.

Different participants may access the virtual object. A user of the application may see the virtual object, or perceive the existence of the virtual object. Advertisers are able to utilize the benefits of the virtual object.

The virtual object and the cash flow definition are stored in a database for further processing.

If it is determined in step 104 that a sub division of the cash flows is needed, then stratifying takes place in step 106 to form securitized packages. Cash flows from the virtual object are divided into different ‘buckets’, or categories. For instance, the cash flows from a keyword search could be divided from the locations of the users who searched that keyword. One such example is to categorize the cash flows from keyword search result ‘Toaster’ into buckets of ‘US based user’ and ‘non-US based user’. A regrouping into a package may follow. For instance, a package is created by grouping all ‘US based user’ buckets into one package, which consists of cash flows resulting from any keyword searches carried out by US users. Each such package has a unique package identifier.

As a result of the packaging, the cash flows from each component inside the package are aggregated and identified. The cash flows are attributable to the owner of the package.

Securitization document(s) is(are) created in step 108 as a result of the securitization which ties the cash flows with the virtual object(s). The securitization document should spell out the name and the identifier of the virtual object, the defined cash flows, the rights and obligations of the owner of the security. The securitization document is stored in the database. The securitization may securitize a single virtual object, multiple virtual objects, or a package described in step 106. The securitization document also should specify the rights and obligations of the application developer. For instance, the securitization document should specify any changes to the cash flow after a future upgrade of the software application, and what would occur should the cash flow definition changes for the virtual object. In addition, the attribution of the cash flow to the underlying security has to be confirmed through a series of test. For instance, the user has to search for the keyword and the search result including the cash flow generating content has to be presented to the user. These requirements are generally included in the securitization document.

In the case where packaging step 106 has occurred, the securitization document should record the package identification and the cash flows identification information. The resulting package security can be owned and traded, like other virtual object security.

An identified cash flow should generally be attributable to only one security or a security package. In the process of re-packaging, if it is found that a cash flow already belongs to another security, then the original security needs to be disassembled into a series of new securities. Each new security needs a new virtual object identification and a new cash flow identification. Take the above ‘Toaster’ keyword as an example, if ‘Toaster’ keyword has already been securitized, then two new securities may be created and replace the original ‘Toaster’ keyword security. Two new securitization documents are created while the original securitization document is retired. Both new securities may inherit some attributes of the original security such as owner information. But one security's virtual object identification becomes ‘Toaster keyword searched by US based user’, and the related cash flow criteria is updated to ‘cash flow as result of US based user searches’. Similarly the other new security's virtual object identification becomes ‘Toaster keyword searched by non-US based user’, and the related cash flow criteria is updated to ‘cash flow as result of non-US based user searches’.

The owner must have thorough understanding of all the risks of the ownership of the security including the price fluctuation of the security in the market place. The securitization document is a product of the securitization process.

A secondary market is developed for trading the ownership of the securitized virtual object in step 110. The secondary market is typically an online place for buyers and sellers to meet and transact. The market may adopt auction model where the seller solicit bids from potential buyers. When the buyers and sellers agree to the prices and terms, the purchase occurs where the buyer pays the seller, and the security ownership changes hands. The trading is managed by a virtual object management module.

In certain aspects, the secondary market place resembles other online security trading. The legal owner of a security is registered in a central database. The money and ownership exchange needs to settle after the transaction where the new owner of the security is updated in the database. The database stores the central ledger records of all securities. Each ledger logs the transaction details, comprising buyer and seller identities, security name and identifier, trade time, trade price and other necessary information. The records are used for multiple purposes, such as auditing, record keeping, cash flow distribution, evidence for transaction and so on.

The cash flow may be distributed to the owner of the securitized virtual object(s) as it is generated in step 112. The cash flow may occur in a real time basis when it happens or may occur on specific dates and hours.

The security ownership may require certain qualifications. For instance, the security ownership may be open only to qualified institutions.

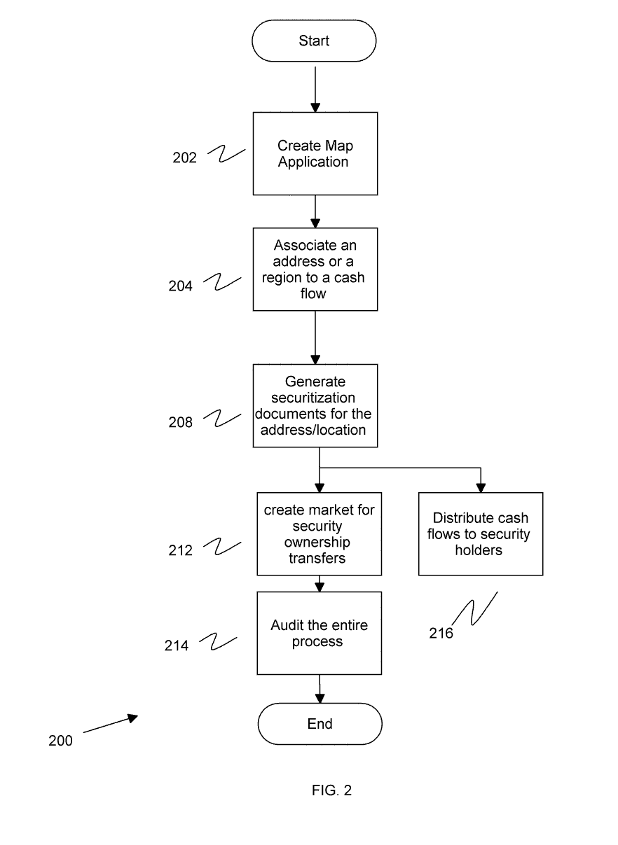

FIG. 2 depicts the flowchart of the securitization of a locations or a region of in a software application.

The process 200 illustrates a securitization of address and locations in a map software application.

Step 202 creates the map application. Step 204 identifies and associates future cash flows with an address or location on the map. For example, virtual billboard displayed on an address would generate advertising cash flows. The cash flow would be attributable to the address.

Securitization document is created in step 208 and the ownership of the address/location security is ready to be assigned. A secondary market for trading such ownership is created in step 212.

Cash flows are distributed to the security owners in step 216.

Auditing the processes maintains the confidence of the participants, which is done in step 214.

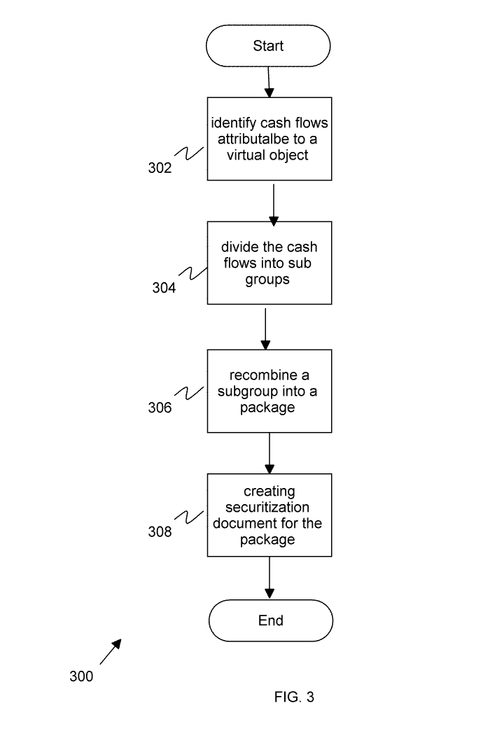

FIG. 3 depicts the flowchart of the securitization of a virtual object package. The process 300 illustrates a process for securitizing a virtual object package or tranche.

A virtual object may generate multiple cash flows depending how to categorize the cash flows. For instance, a keyword search may generate cash flows from users of different countries. Step 302 identifies such cash flows. Step 304 divides the cash flows into sub groups with labels for each group. For instance, one label example is ‘users from the United States’.

Step 306 takes one subgroup and puts it in a package. The package or tranche has other subgroups with the same of similar label. For instance, the package may consist of subgroups with label ‘users from the United States’.

Step 308 would create the securitization document for the package to clearly identify the rights, terms and conditions for the ownership of such package. The package is ready for ownership assignment.

Many of the above-described example processes 100, 200, and 300, and related features and applications, may be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

The term “software” is meant to include, where appropriate, firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

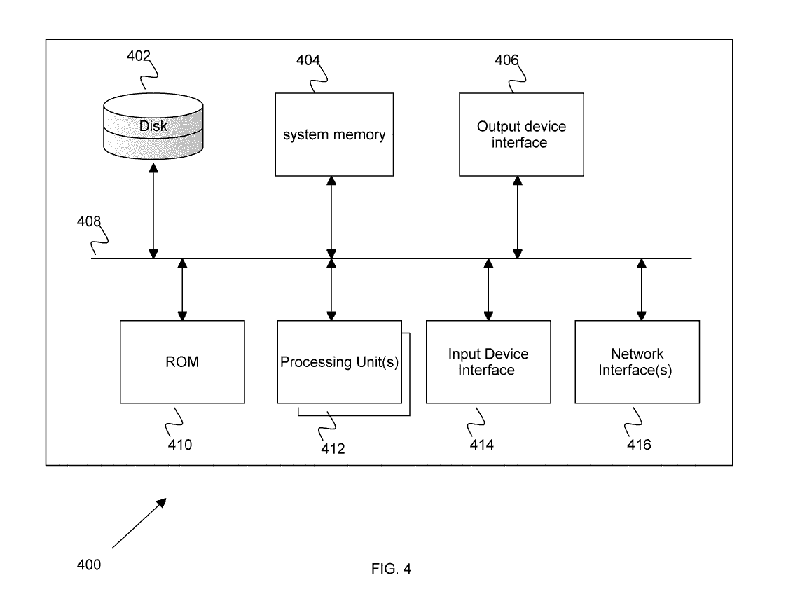

FIG. 4 depicts an example electronic system for use in connection with the securitization of a virtual object. Electronic system 400 may be a computing device for execution of software associated with the operation of one or more portions or steps of process 100, 200 or 300, or components and processes provided by FIGS. 1-3. Electronic system 400 may be a personal computer or a mobile device such as a tablet computer, laptop, smart phone, PDA, or other touch screen or television with one or more processors embedded therein or coupled thereto, or any other sort of computer-related electronic device having wireless connectivity.

Electronic system 400 may include various types of computer readable media and interfaces for various other types of computer readable media. In the depicted example, electronic system 400 includes a bus 408, processing unit(s) 412, a system memory 404, a read- only memory (ROM) 410, a permanent storage device 402, an input device interface 414, an output device interface 406, and one or more network interfaces 416. In some implementations, electronic system 400 may include or be integrated with other computing devices or circuitry for operation of the various components and processes previously described.

Bus 408 collectively represents a system, peripheral, and chipset buses that communicatively connect the numerous internal devices of electronic system 400. For instance, bus 408 communicatively connects processing unit(s) 412 with ROM 410, system memory 404, and permanent storage device 402.

From these various memory units, processing unit(s) 412 retrieves instructions to execute and data to process in order to execute the processes of the subject disclosure. The processing unit(s) can be a single processor or a multi-core processor in different implementations.

ROM 410 stores static data and instructions that are needed by processing unit(s) 412 and other modules of the electronic system. Permanent storage device 402, on the other hand, is a read-and-write memory device. This device is a non-volatile memory unit that stores instructions and data even when electronic system 400 is off. Some implementations of the subject disclosure use a mass-storage device (such as a magnetic or optical disk and its corresponding disk drive) as permanent storage device 402.

Other implementations use a removable storage device (such as a floppy disk, flash drive, and its corresponding disk drive) as permanent storage device 402. Like permanent storage device 402, system memory 404 is a read-and-write memory device. However, unlike storage device 402, system memory 404 is a volatile read-and-write memory, such a random access memory. System memory 404 stores some of the instructions and data that the processor needs at runtime. In some implementations, the processes of the subject disclosure are stored in system memory 404, permanent storage device 402, and/or ROM 410. From these various memory units, processing unit(s) 412 retrieves instructions to execute and data to process in order to execute the processes of some implementations.

Bus 408 also connects to input and output device interfaces 414 and 406. Input device interface 414 enables the user to communicate information and select commands to the electronic system. Input devices used with input device interface 414 include, for example, alphanumeric keyboards and pointing devices (also called “cursor control devices”). Output device interfaces 406 enables, for example, the display of images generated by the electronic system 400. Output devices used with output device interface 406 include, for example, printers and display devices, such as cathode ray tubes (CRT) or liquid crystal displays (LCD). Some implementations include devices such as a touchscreen that functions as both input and output devices.

Finally, as shown in FIG. 4, bus 408 also couples electronic system 400 to a network (not shown) through network interfaces 416. Network interfaces 416 may include, for example, a wireless access point (e.g., Bluetooth or WiFi) or radio circuitry for connecting to a wireless access point. Network interfaces 416 may also include hardware (e.g., Ethernet hardware) for connecting the computer to a part of a network of computers such as a local area network (“LAN”), a wide area network (“WAN”), wireless LAN, or an Intranet, or a network of networks, such as the Internet. Any or all components of electronic system 400 can be used in conjunction with the subject disclosure.

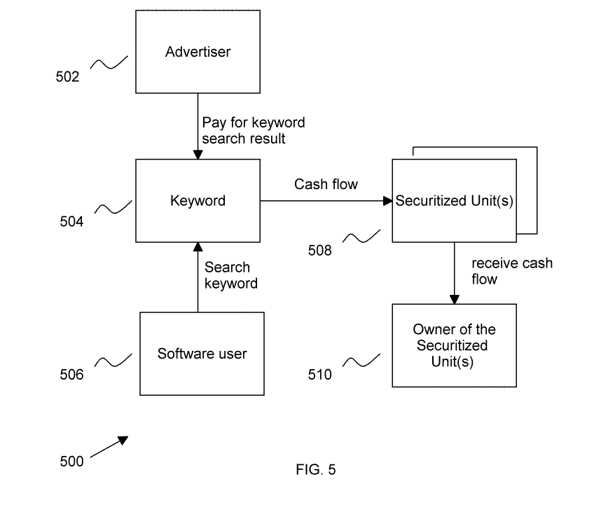

FIG. 5 depicts an example diagram of the relationship between various components of the securitization system. In this case, the example for the virtual object is the keyword used in a search engine.

The relationship diagram 500 depicts how the cash flow moves. An advertiser 502 pays for being placed in the result of a keyword search. When the keyword 504 is being searched by the software user 506, the ad is viewed or clicked by the user.

The keyword 504 has been securitized into one or more securitized unit(s) 508. During securitization, the cash flow can be sub divided based on other characteristics such as user locations. Each sub division can be repackaged along with any other sub divisions of the same or different keywords. The resulting package is also called tranche. The cash flow will be attributable to the corresponding securitized unit(s) or securitized package(s).

The owner of the securitized unit(s) 510 receives the cash flow according to the securitization documents.

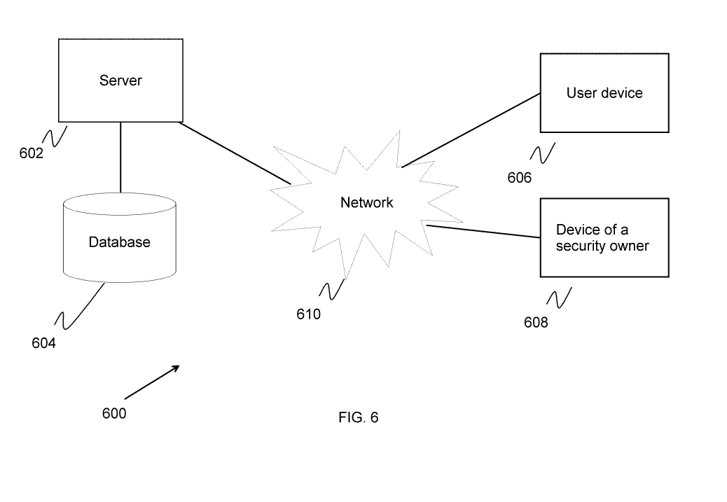

FIG. 6 depicts an example system diagram in a network environment. The system depicted in 600 illustrates a typical use case involving a network. Network 610 may include a large computer network, examples of which include a local area network (LAN), wide area network (WAN), the Internet, a cellular network, or a combination thereof connecting a number of mobile computing devices, fixed computing devices, and server systems. The network(s) included in network 610 may provide for communications under various modes or protocols, examples of which include Transmission Control Protocol/Internet Protocol (TCP/IP), Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. Communication may occur through a radio-frequency transceiver. In addition, short-range communication may occur, e.g., using a BLUETOOTH, WiFi, or other such transceiver system.

The network 610 connects various hardware devices, such as server 602, a user device 606, and a device 608 used by a security owner.

The user device 606 and the device of a security owner 608 may include, e.g., a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an electronic messaging device, a game console, or a combination of two or more of these data processing devices or other appropriate data processing devices.

A browser or a front end component of the software application may be installed on the user device 606. The device 606 accesses the software application and virtual objects that are hosted on server 602 and the database 604 via the network 610.

When the user device 606 accesses a virtual object, the server 602 searches the database 604 to retrieve the securitization document associated with that virtual object. The server 602 starts recording the cash flow attributed to that virtual object according to the securitization document.

The cash flow information is stored in the database 604 along with the virtual object identifier. The information is also transmitted to the device of the security owner device 608 upon a request from the security owner device 608.

The server 602 also hosts a virtual object security management module that is responsible for managing the securities. The module has connection with the software application to receive actions on the virtual objects. The module matches appropriate cash flows with the right virtual object and its security. The module also updates the entries in the securitization document.

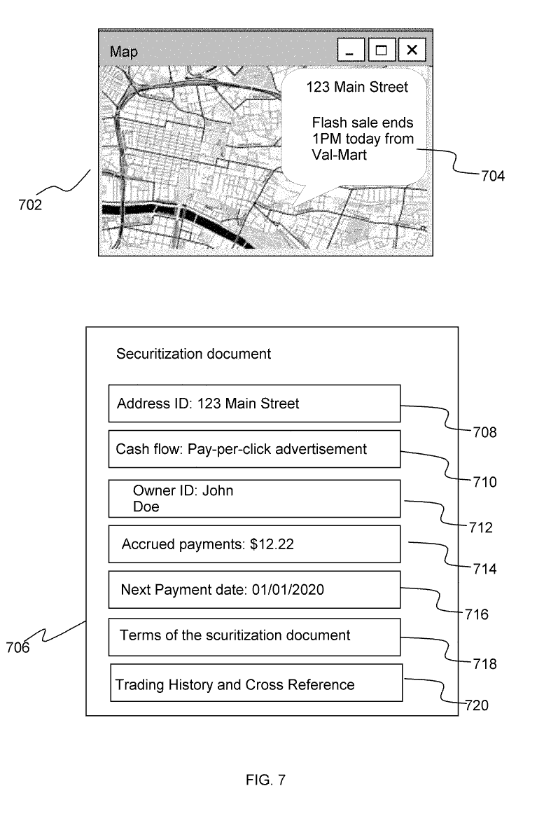

FIG. 7 depicts a map application, a virtual object representation, and a securitization document sample. To make it more illustrative, FIG. 7 may be viewed in conjunction with FIG. 6.

The user device 606 in FIG. 6 sees a map application user interface as shown in 702. The user's mouse may hover above an address ‘123 Main Street’ on the map. This address is a digital record of the map application. What the address represents on the map is a virtual object. A pop up window 704 is shown to the user. The content comprises an advertisement about a flash sale. The pop up window may also be shown automatically based on the user's current location.

The server 602 in FIG. 6 searches the address ‘123 Main Street’ in the database 604 of FIG. 6 for a related securitization document. In this case, the address itself could be used as the virtual object identifier.

A securitization document 706 is retrieved from the database 604 by the server 602 of FIG. 6 by the address ID. The advertiser of the pop up window pays certain cash flow for certain user action such as ‘pay per click’. The server 602 compares the user action with the qualified cash flow generation criteria 710. If the user action indeed qualifies for the cash flow, then the cash flow is attributed to the security owner 712 recorded in the securitization document 706.

The securitization document comprises entries that are necessary for the virtual object security management system. The address ID 708 serves as the securitization ID. The cash flow definition 710 specifies what types of cash flow is attributable to this security.

The owner ID 712 records the current owner, or title holder of the security. Accrued payment 714 indicates the cash amount that has not yet been paid to the owner 712. Entry 716 indicates the time of the next cash disbursement to the security owner 712. The terms of the securitization document 718 detail the rights and obligations of the security owner and other terms between participants.

Trading history 720 links the security with trading activities of the security.

A trading management module may be hosted by the server 602 in FIG. 6, which deals with all trading related services for the securities. A trading module may comprise price matching, ownership registration, payment settlement and trade recording. The device of the security owner 608 may buy or sell the security of a virtual object. Whenever a trading of the virtual object ‘123 Main Street’ occurs, the trading management module is responsible for updating the proper current owner in entry owner ID 712, and the trading history/cross reference entry 720.

The device of a security owner 608 in FIG. 6 may access the securitization document 706 by sending a viewing request to the server 602. The server 602 retrieves the appropriate securitization document 706 from the database 604, and then sends it over the network 610 to the security owner device 608.

The cash flow accrued in 714 is to be paid out on the next payment date indicated in 716 to the then current owner 712.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention. The term website, as used herein, may include any aspect of a website, including one or more web pages, one or more servers used to host or store web related content, and the like. Accordingly, the term website may be used interchangeably with the terms web page and server. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

References to “one embodiment,” “an embodiment,” “some embodiments,” “various embodiments”, or the like indicate that a particular element or characteristic is included in at least one embodiment of the invention. Although the phrases may appear in various places, the phrases do not necessarily refer to the same embodiment. In conjunction with the present disclosure, those skilled in the art will be able to design and incorporate any one of the variety of mechanisms suitable for accomplishing the above described functionalities.

It is to be understood that the disclosure teaches just one example of the illustrative embodiment and that many variations of the invention can easily be devised by those skilled in the art after reading this disclosure and that the scope of then present invention is to be determined by the following claims.

What is claimed is:

1. A virtual object securitization method comprising:
creating a virtual object in a software application;
identifying future cash flows related to the virtual object;
generating a securitization document for the virtual object wherein the securitization document comprises the cash flow identification, and the virtual object identification; and
assigning ownership of the security.

2. The method according to claim 1, further comprising:
creating a market place to trade the ownership of the security.

3. The method according to claim 1, further comprising:
stratifying the cash flows into sub categories for the virtual object;
regrouping one or more of the sub categories into a package; and
generating an additional securitization document for the package, wherein the additional security document comprises the cash flow identification and the package identification.

4. The method of claim 1, wherein the virtual object is a location on a map application.

5. The method of claim 1, wherein the virtual object is a keyword used in search.

6. The method of claim 1, wherein the virtual object is a piece of virtual equipment used in a computer game.

7. The method of claim 1, wherein the virtual object is a place for presenting content in the software application.

8. A system, comprising:
one or more processors; and
a memory including instructions that, when executed by the one or more processors, cause the one or more processors to facilitate the steps of:
creating a virtual object in a software application;
identifying future cash flows related to the virtual object;
generating a securitization document for the virtual object wherein the securitization document comprises cash flow identification, and the virtual object identification; and
assigning ownership of the security.

9. The system according to claim 8, further comprising:
creating a market place to trade ownership of the security.

10. The system according to claim 8, further comprising:
stratifying the cash flows into sub categories for the virtual object;
regrouping one or more of the sub categories into a package; and
generating an additional securitization document for the package, wherein the additional security document comprises the cash flow identification and the package identification.

11. The system according to claim 8, wherein the virtual object is a location on a map application.

12. The system according to claim 8, wherein the virtual object is a keyword of a search engine.

13. The system according to claim 8, wherein the virtual object is a piece of equipment used in a computer game.

14. The system according to claim 8, wherein the virtual object presents content in the software application.

15. A non-transitory computer-readable storage medium comprising instructions that, when executed, facilitate the steps of:
creating a virtual object in a software application;
identifying future cash flows related to the virtual object;
generating a securitization document for the virtual object wherein the securitization document comprises cash flow identification, and the virtual object identification; and
assigning ownership of the security.

16. The non-transitory computer-readable storage medium of claim 15, further comprising instructions that, when executed, facilitate the steps of:
creating a market place to trade ownership of the security.

17. The non-transitory computer-readable storage medium of claim 15, further comprising instructions that, when executed, facilitate the steps of:
stratifying the cash flows into sub categories for the virtual object;
regrouping one or more of the sub categories into a package; and
generating an additional securitization document for the package, wherein the additional security document comprises the cash flow identification and the package identification.
